(19) United States
(12) Patent Application Publication
(10) Pub. No.: US 2019/0190336 A1
(43) Pub. Date: Jun. 20, 2019

(54) METHOD AND APPARATUS FOR COOLING A ROTOR ASSEMBLY

(71) Applicant: GE Aviation Systems LLC, Grand Rapids, MI (US)

(72) Inventors: Balamurugan Sridharan, Bangalore (IN); Prateek Jalan, Bangalore (IN); Anirban Chatterjee, Bangalore (IN); David Raju Yamarthi, Bangalore (IN); Mohammad Khaja Mohiddin Shaik, Bangalore (IN)

(21) Appl. No.: 15/849,086

(22) Filed: Dec. 20, 2017

(51) Int. Cl. H02K 1/32; H02K 3/24; H02K 1/24

(52) U.S. Cl. CPC H02K 1/32; H02K 1/24; H02K 3/24

(57) ABSTRACT

A method and apparatus for cooling a rotor assembly includes a rotor core having a rotatable shaft and defining at least one rotor post, and a set of windings wound around the post and including a coolant conduit relative to the set of windings and wherein the coolant conduit is in a thermally conductive relationship with a portion of the windings.

### BACKGROUND OF THE INVENTION

Contemporary aircraft engines include electric machines, or generator systems, which utilize a running aircraft engine in a generator mode to provide electrical energy to power systems and components on the aircraft. Some aircraft engines can further include starter/generator systems, which act as a motor to start an aircraft engine, and as a generator to provide electrical energy to power systems on the aircraft after the engine is running. Motors and generators can be wet cavity systems, wherein a cavity housing the rotor and stator is exposed to liquid coolant, or dry cavity systems, wherein the cavity is not exposed to liquid coolant. Dry cavity systems can also utilize liquid coolant in one or more contained cooling systems, but they are still considered dry cavity so long as the cavity is not exposed to liquid coolant.

### BRIEF DESCRIPTION OF THE INVENTION

In one aspect, the present disclosure relates to a rotor assembly for an electric machine including a rotor core having a rotatable shaft and defining at least one rotor post, and a set of windings wound around the post and including a coolant conduit through-opening in the set of windings and extending axially along the post through the set of windings, and wherein the coolant conduit is in a thermally conductive relationship with a portion of the windings. Heat generated in the set of windings when the rotor core rotates is transferred by conduction to a coolant flow in the coolant conduit.

In another aspect, the present disclosure relates to a rotor assembly for an electric machine including a rotor core having a rotatable shaft and defining at least one rotor post, the at least one rotor post having a first axial end and a spaced second axial end, a set of rotor windings wound around the post between the first and second axial ends, and a set of radially and laterally-spaced coolant conduit through-openings in the set of windings extending axially between the first and second axial ends, and in a thermally conductive relationship with the set of rotor windings. The set of coolant conduits are internal to the set of windings.

In yet another aspect, the present disclosure relates to a method of cooling a rotatable electric machine rotor, including directing a fluid coolant flow to an array of coolant conduits extending axially through a set of rotor windings, wherein the array of coolant conduits are in a thermally conductive relationship with the set of rotor windings, so that the fluid coolant flow removes heat from the set of rotor windings as the rotor rotates.

### BRIEF DESCRIPTION OF THE DRAWINGS

In the drawings:

FIG. 1 is an isometric view of a gas turbine engine having a generator, in accordance with various aspects described herein.

FIG. 2 is an isometric view of an exterior of the generator of FIG. 1, in accordance with various aspects described herein.

FIG. 3 is a schematic cross-sectional view of the generator of FIG. 2, taken along line of FIG. 2, in accordance with various aspects described herein.

FIG. 4 illustrates a schematic view of a rotor portion illustrating a cross-sectional view of a set of windings of the generator of FIG. 3, including a liquid cooling circuit, in accordance with various aspects described herein.

FIG. 5 illustrates a schematic cross-sectional view, taken along line V-V of FIG. 4, illustrating a set of radial openings of the rotor portion, in accordance with various aspects described herein.

### DESCRIPTION OF EMBODIMENTS OF THE INVENTION

Aspects of the disclosure can be implemented in any environment using an electric motor regardless of whether the electric motor provides a driving force or generates electricity. For purposes of this description, such an electric motor will be generally referred to as an electric machine, electric machine assembly, or similar language, which is meant to clarify that one or more stator/rotor combinations can be included in the machine. While this description is primarily directed toward an electric machine providing power generation, it is also applicable to an electric machine providing a driving force or an electric machine providing both a driving force and power generation. Further, while this description is primarily directed toward an aircraft environment, aspects of the disclosure are applicable in any environment using an electric machine. Thus, a brief summary of a contemplated environment should aid in a more complete understanding.

While “a set of” various elements will be described, it will be understood that “a set” can include any number of the respective elements, including only one element. As used herein, the terms “axial” or “axially” refer to a dimension along a longitudinal axis of a generator or along a longitudinal axis of a component disposed within the generator.

As used herein, the terms “radial” or “radially” refer to a dimension extending generally between a center longitudinal axis, an outer circumference, or a circular or annular component disposed thereof. Aspects of the disclosure can include components that are not oriented in a “strictly” radial dimension, that is, components having a radial dimension but not oriented perfectly between the center longitudinal axis and an outer circumference. As used herein, the term “laterally” can refer to a dimension generally or relatively perpendicular to a radial dimension. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component.

All directional references (e.g., radial, lateral, axial, upper, lower, upward, downward, left, right, lateral, front, back, top, bottom, above, below, vertical, horizontal, clockwise, counterclockwise) are only used for identification purposes to aid the reader's understanding of the disclosure, and do not create limitations, particularly as to the position, orientation, or use thereof. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other.

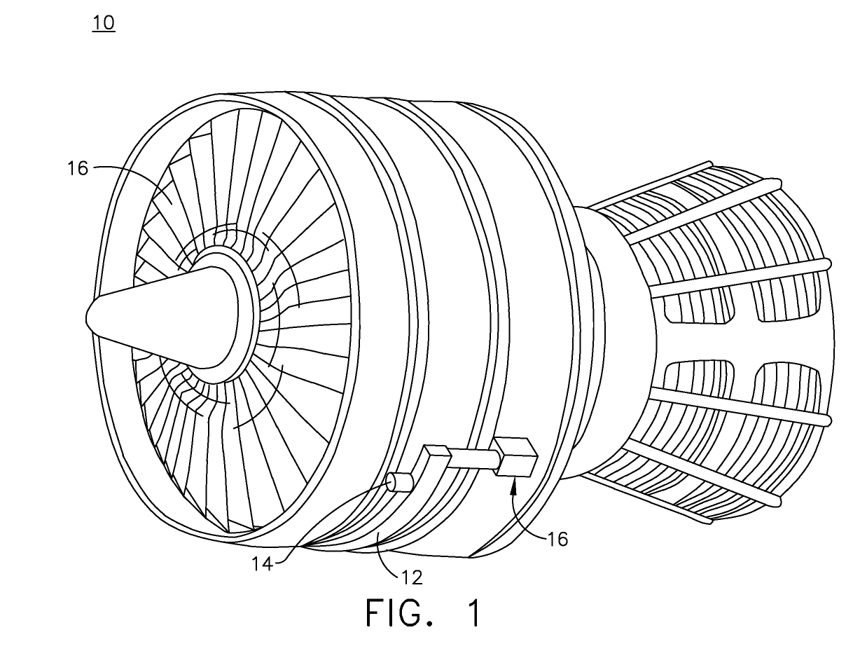

FIG. 1 illustrates a gas turbine engine 10 having an accessory gear box (AGB) 12 and a generator 14 according to an aspect of the disclosure. The gas turbine engine 10 can be a turbofan engine, such as a General Electric GEnx or CF6 series engine, commonly used in modern commercial and military aviation or it could be a variety of other known gas turbine engines such as a turboprop or turboshaft. The gas turbine engine 10 can also have an afterburner that burns an additional amount of fuel downstream of the low pressure turbine region to increase the velocity of the exhausted gases, and thereby to increase thrust. The AGB 12 can be coupled to a turbine shaft (not shown) of the gas turbine engine 10 by way of a mechanical power take off 16. The gas turbine engine 10 can be any suitable gas turbine engine used in modern commercial and military aviation or it could be a variety of other known gas turbine engines such as a turboprop or turboshaft. The type and specifics of the gas turbine engine 10 are not germane to the disclosure and will not be described further herein. While a generator 14 is shown and described, aspects of the disclosure can include any electrical machine or generator.

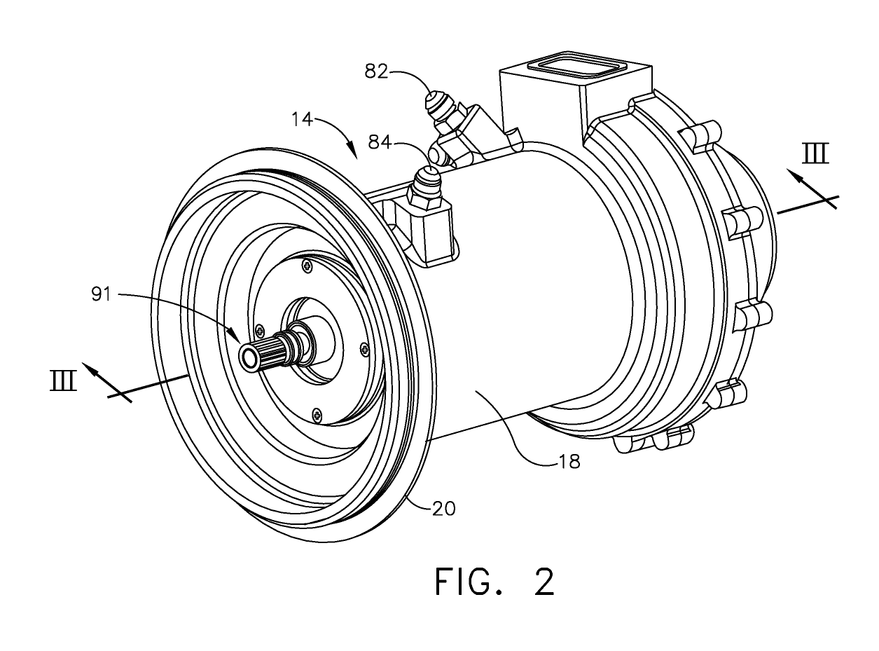

FIG. 2 more clearly illustrates the generator 14 and its housing 18, which can include a clamping interface 20, used to clamp the generator 14 to the AGB 12. Multiple electrical connections can be provided on the exterior of the generator 14 to provide for the transfer of electrical power to and from the generator 14. The electrical connections can be further connected by cables to an electrical power distribution node of an aircraft having the gas turbine engine 10 to power various items on the aircraft, such as lights and seat-back monitors. The generator 14 includes a liquid coolant system for cooling or dissipating heat generated by components of the generator 14 or by components proximate to the generator 14, one non-limiting example of which can be the gas turbine engine 10. For example, the generator 14 can include a liquid cooling system using oil as a coolant.

The liquid cooling system can include a cooling fluid inlet port 82 and a cooling fluid outlet port 84 for controlling the supply of coolant to the generator 14. In one non-limiting example, the cooling fluid inlet and output ports 82, 84 can be utilized for cooling at least a portion of a stator of the generator 14. The liquid cooling system can also include a second coolant outlet port 91, shown at a rotatable shaft portion of the generator 14 (described below). While only a coolant outlet port 91 is shown in the illustrated isometric view, a rotor or rotatable shaft coolant inlet port can be included. While not shown, aspects of the disclosure can further include other liquid cooling system components, such as a liquid coolant reservoir fluidly coupled with the cooling fluid inlet port 82 and cooling fluid outlet port 84, and a liquid coolant pump to forcibly supply the coolant through the ports 82, 84 or generator 14. Oil is merely one non-limiting example of a liquid coolant that can be used in aspects of the disclosure.

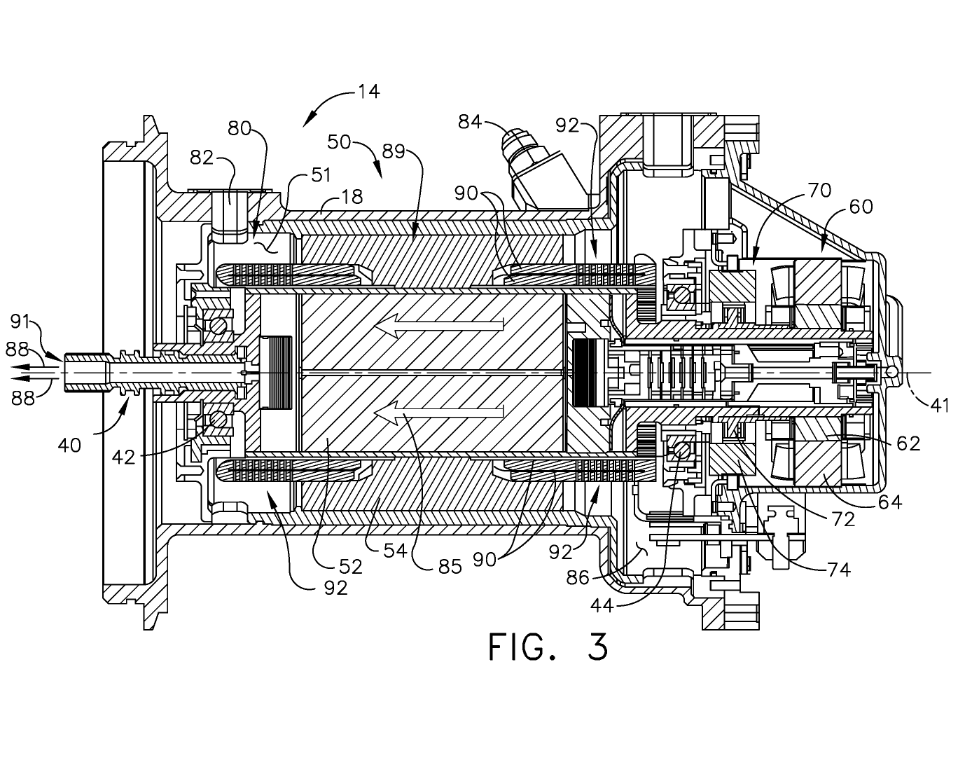

The interior of the generator 14 is best seen in FIG. 3, which is a sectional view of the generator 14 shown in FIG. 2. A rotatable shaft 40 is located within the generator 14 and is the primary structure for supporting a variety of components. The rotatable shaft 40 can have a single diameter or one that can vary along its length. The rotatable shaft 40 is supported by spaced bearings 42 and 44 and configured to rotate about axis of rotation 41. Several of the elements of the generator 14 have a fixed component and a rotating component, with the rotating component being provided on the rotatable shaft 40. Examples of these elements can include a main machine 50, housed within a main machine cavity 51, an exciter 60, and a permanent magnet generator (PMG) 70. The corresponding rotating component comprises a main machine rotor 52, an exciter rotor 62, and a PMG rotor 72, respectively, and the corresponding fixed component comprises a main machine stator 54 or stator core, an exciter stator 64, and a PMG stator 74. In this manner, the main machine rotor 52, exciter rotor 62, and PMG rotor 72 are disposed on the rotatable shaft 40. The fixed components can be mounted to any suitable part of the housing 18. The main machine stator 54, exciter stator 64, and PMG stator 74 define an interior through which the rotatable shaft 40 extends.

It will be understood that the main machine rotor 52, exciter rotor 62, and PMG rotor 72 can each have a set of rotor poles, including, but not limited to two rotor poles having corresponding sets of windings, and that the main machine stator 54, exciter stator 64, and PMG stator 74 can each have a set of stator teeth or stator poles, including, but not limited to two stator teeth or stator poles. The set of rotor poles can generate a set of magnetic fields relative to the set of stator poles, such that the generator 14 can operate through the interaction of the magnetic fields and current-carrying conductors to generate force or electrical power. The exciter 60 can provide direct current to the main machine 50 and the main machine 50 and PMG 70 can supply AC electrical power when the rotatable shaft 40 rotates.

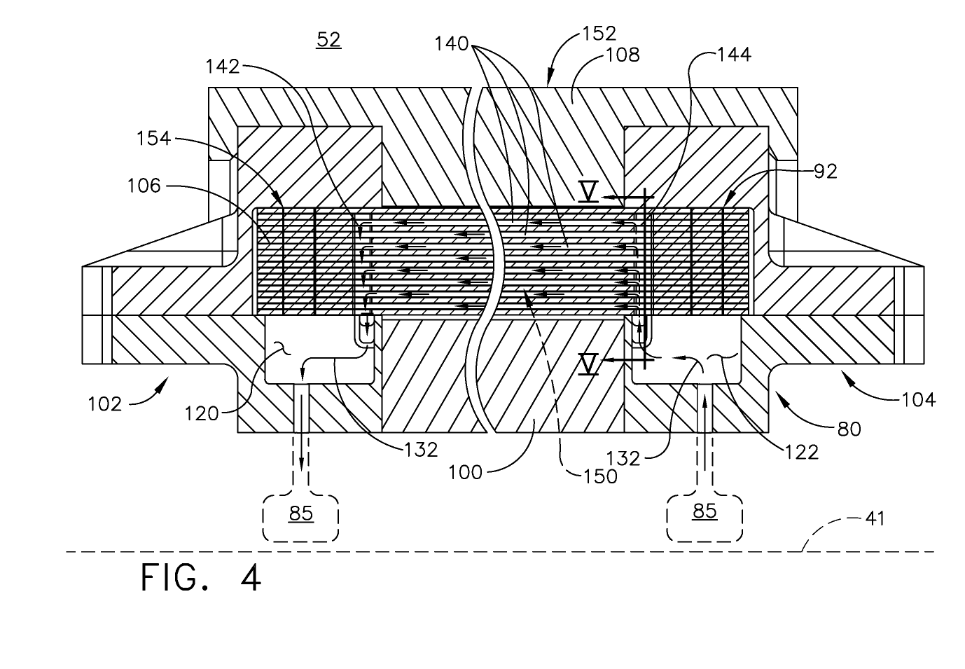

At least one of the rotor poles can be formed by a core with a post and wire wound about the post to form a winding, with the winding having at least one end turn. The main machine rotor 52, rotor poles, and rotor windings are further illustrated and described with respect to FIG. 4. Aspects of the disclosure shown in FIG. 3 include at least one set of stator windings 90 arranged longitudinally along the stator housing 18, that is, in parallel with housing 18 and the rotor axis of rotation 41. The set of stator windings 90 can also include a set of stator winding end turns 92 extending axially beyond opposing ends of a longitudinal length of a main machine stator 54.

The components of the generator 14 can be any combination of known generators. For example, the main machine 50 can be either a synchronous or asynchronous generator. In addition to the accessories shown in this aspect, there can be other components that need to be operated for particular applications. For example, in addition to the electromechanical accessories shown, there can be other accessories driven from the same rotatable shaft 40 such as the liquid coolant pump, a fluid compressor, or a hydraulic pump.

As explained above, the generator 14 can be oil cooled and thus can include a cooling system 80. The cooling oil can be used to dissipate heat generated by the electrical and mechanical functions of the generator 14. The cooling system 80 using oil can also provide for lubrication of the generator 14. In the illustrated aspects, the generator 14 can be a liquid cooled, dry cavity system having the cooling system 80 illustrated as including the cooling fluid inlet port 82 and the cooling fluid outlet port 84 for controlling the supply of the cooling fluid to the cooling system 80. The cooling system 80 can further include, for example, a cooling fluid reservoir and various cooling passages. In addition or alternatively, the generator 14 can be a liquid cooled, wet cavity system wherein the rotatable shaft 40 can provide one or more flow channels or paths (shown as arrows 85) for the main machine rotor 52, exciter rotor 62, and PMG rotor 72, as well as a rotor shaft oil outlet 88, such as the outlet port 91, wherein residual, unused, or unspent oil can be discharged from the rotatable shaft 40.

FIG. 4 illustrates a zoomed view of the main machine rotor 52 or rotor assembly, for better understanding of the operation and effect of the cooling system 80. While FIG. 4 illustrates a single axially-extending portion of the set of windings 106, aspects of the disclosure can be included wherein, for instance, the set of windings 106 are wound about a post 150 such that there are multiple (e.g. at least two) axially-extending portions of the set of windings 106. In this instance, each axially-extending portion of the set of windings 106 can be adapted, as explained herein.

As shown, the main machine rotor 52 can include a rotor core 100, such as a laminated rotor core, rotatably connected to co-rotate with the rotatable shaft 40. The main machine rotor 52 can further define a first end 102 of the rotor 52 and a second end 104 of the rotor 52, spaced axially from the first end 102. The main machine rotor 52 can include at least one rotor pole 152 formed when at least a portion of the rotor core 100 is wound with conductive wiring (i.e. a “winding”) about the post 150. Collectively, the multiple windings of the conductive wiring forms a set of rotor windings 106. In the perspective of the illustrated example, the rotor post 150 can underlie the set of rotor windings 106.

Each set of rotor windings 106, while continuous, can be thought of as having axial segments that run along opposite sides of the pole 152 (e.g. in parallel with the axis of rotation 41), with opposing end turn 154 segments on opposite ends 102, 104 of the rotor core 100 connecting the axial segments. While only one example of a set of rotor windings 106 are illustrated, aspects of the disclosure can include having multiple sets or rotor windings 106 configured about one or more circumferentially spaced poles 152 of the main machine rotor 52, such as a portion of a salient pole generator.

Each pole 152 of the main machine rotor 52 can further include a cap 108, at least partially overlaying each pole 152 and set of rotor windings 106. In one non-limiting example, the rotor core 100 and cap 108 can be formed or comprised by a plurality of laminations, for instance, cobalt laminations. Cobalt laminations are merely one example of a material used to construct the core 100 or cap 108, and alternate material composition or compositions may be included.

The cooling system 80 for the main machine rotor 52 can include a set or series of fluid conduits, passageways, or the like, wherein a coolant fluid can be supplied or otherwise delivered there through for removing heat from the main machine rotor 52, the set of rotor windings 106, or a combination thereof. As shown, a portion of the rotor core 100 proximate to the first end 102 can define a first coolant cavity 120 or reservoir fluidly connected with the oil flow channel 85 of the rotor 52 (schematically illustrated). Similarly, another portion of the rotor core 100 proximate to the second end 104 can define a second coolant cavity 122 or reservoir fluidly connected with the oil flow channel 85 of the rotor 52. In this example, one of the coolant cavities 120, 122 (shown as the second coolant cavity 122) can receive a fluid coolant flow, while the other of the coolant cavities 122, 120 (such as the first coolant cavity 120) can supply or return a fluid coolant flow back to the oil flow channel 85 or another coolant reservoir or flow. As shown, the fluid coolant flow is illustrated schematically as arrows 132.

The cooling system 80 of the main machine rotor 52 can also include a first coolant conduit 140 or set of first coolant conduits 140 supported by the set of rotor windings 106 and adapted, configured, disposed, or the like to extend axially along, through, or internal to the rotor post 150 or pole 152, axis of rotor 41 rotation, or the like. In one non-limiting example, the set of first coolant conduits 140 can be radially spaced through the set of rotor windings 106, that is, arranged, disposed, located, or the like, at different radii through the set of rotor windings 106. In this example, “radially spaced” denotes a relative position radially closer to the axis of rotation 41, relative to the set of rotor windings 106, between the set of rotor windings 106 and the rotor core 100, but not necessarily in a “strict” radial direction, as previously described. Stated another way, in the perspective of FIG. 4, the set of first coolant conduits 140 run parallel to, and internally through, the set of rotor windings 106. At least one face of each of the set of first coolant conduits 140 can be in a thermally conductive relationship with a proximate portion or face of the set of rotor windings 106.

The cooling system 80 of the main machine rotor 52 can also include a set of radial openings, such as a through-opening, non-limiting examples of which can include a radially-oriented conduit, a second coolant conduit 142, or a second set of coolant conduits 142 supported by the set of rotor windings 106 and adapted, configured, disposed, or the like to extend radially through a portion of the set of rotor windings 106 or rotor winding end turns 154 proximate to one of the first or second ends 102, 104. As shown, the second set of coolant conduits 142 includes a conduit proximate to the first end 102 that fluidly connects the first coolant cavity 120 with a set of first ends of the set of first coolant conduits 140. In this sense, the set of first coolant conduits 140 are fluidly connected with the first coolant cavity 120 by way of the radially-extending, radially-orientated, or radially-arranged set of second coolant conduits 142.

Similarly, the cooling system of the main machine rotor 52 can also include another set of radial openings, such as a through-opening, non-limiting examples of which can include a radially-oriented conduit, a third coolant conduit 144, or a third set of coolant conduits 144 supported by the set of rotor windings 106 and adapted, configured, disposed, or the like to extend radially through another portion of the set of rotor windings 106 or rotor winding end turns 154 proximate to the other of the first or second ends 102, 104. As shown, the third set of coolant conduits 144 includes a conduit proximate to the second end 104 that fluidly connects the second coolant cavity 122 with a set of second ends of the set of first coolant conduits 140, wherein the second end of the first coolant conduits 140 is spaced from the first end. In this sense, the set of first coolant conduits 140 are fluidly connected with the second coolant cavity 122 by way of the radially-extending, radially-orientated, or radially-arranged set of third coolant conduits 144. At least a portion of the set of second coolant conduits 142, the set of third coolant conduits 144, or a combination thereof, can be in a thermally conductive relationship with a proximate portion or face of the set of rotor windings 106 or end turns 154.

In one non-limiting example, the set of rotor windings 106 or end turns 154 can be cut, formed, wound, or otherwise configured such that the set of windings 106 themselves define the one or more of the set of first, second, or third coolant conduits 140, 142, 144. In another non-limiting example, the set of rotor windings 106 or end turns 154 can include a set of independently-formed conduits or passages (e.g. a housing having sidewalls defining a fluid channel) disposed in, around, or in between the conductive wires of the respective set of rotor windings 106 or end turns 154.

Thus, aspects of the disclosure can include a cooling system 80 defined by, or including a coolant flow path (for example, denoted by the fluid coolant flow 132), whereby coolant supplied from a coolant source (such as the oil flow channel 85) can be provided to the set of first coolant conduits 140, and traverse the set of first coolant conduits 140 to remove heat generated in the set of windings 106 during generator operations. The coolant flow path can further be provided from the oil flow channel 85 to one of the first or second coolant cavities 120, 122 (shown as the second coolant cavity 122), radially through a corresponding one of the set of second or third coolant conduits 142, 144 (shown as the third coolant conduit 144). The coolant flow path can further be provided from the one of the set of second or third coolant conduits 142, 144 through the set of the radially-spaced first coolant conduits 140, whereby the coolant flow is received by the other of the set of second or third coolant conduits 142, 144 (shown as the second coolant conduit 142). The coolant flow path can then be provided from the other of the set of second or third coolant conduits 142, 144 to the other of the first or second coolant cavities 120, 122 (shown as the first coolant cavity 120), whereby the coolant flow can be returned to the oil flow channel 85, or delivered to another cooling system 80 destination.

The fluid coolant flow 132 can receive a conductive transfer of heat from the set of rotor windings 106, the end turns 154, the proximate portions of the rotor core 100, the cap 108, or a combination thereof, and carry away the aforementioned heat, effectively or operably cooling the main machine rotor 52. In one non-limiting example, the radial spacing of the set of first coolant conduits 140 can be selected, configured, adapted, or the like, to ensure sufficient or adequate conductive heat transfer from the set of rotor windings 106 to the fluid coolant flow 132 during expected generator operations, for instance to ensure an even, balanced, or distributed heating or cooling of the set of rotor windings 106. For instance, the configuration of the radially-spaced set of first coolant conduits 140 can be adapted to ensure the radially distal portions of the set of windings 106 and the radially proximal (e.g. closer to the axis of rotation 41) portions of the set of windings 106 do not experience abnormal heating or heat retention during expected generator operating conditions.

As described herein, the fluid coolant flow 132 can be defined in a sequentially-directed flow pathway including the set of third coolant conduits 144, the set of first coolant conduits 140, the set of second coolant conduits 142, or a combination thereof.

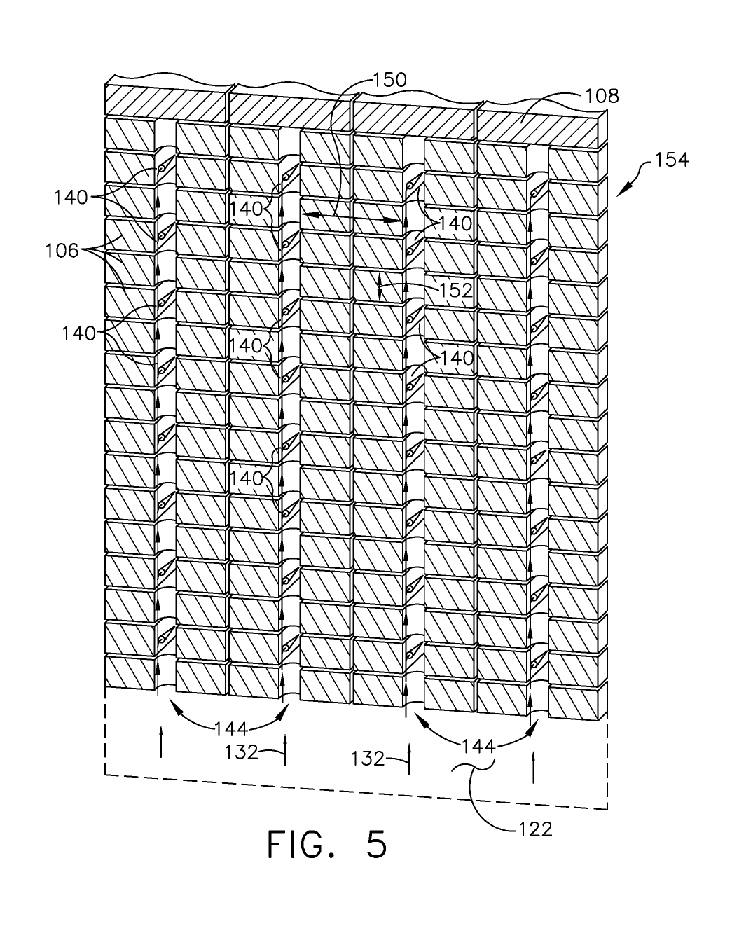

FIG. 5 illustrates an isometric cross-sectional view of the end turns 154 or set of rotor windings 106 of the main machine rotor 52 proximate to the second end 104, taken along line V-V of FIG. 4, for ease of understanding. While aspects of the disclosure shown in FIG. 5 will be explained with respect to the set of third coolant conduits 144, the following aspects can be equally applicable with respect to the second coolant conduits 142. As shown, the set of third coolant conduits 144 can extend radially from the second coolant cavity 122, through a portion of the set of windings 106 or end turns 154, up to the cap 108. The set of third coolant conduits 144 is fluidly connected with the set of first coolant conduits 140, as illustrated by the fluid coolant flow 132. Also as shown, aspects of the disclosure can include radial spacing 152 between adjacent first coolant conduits 140, as well as lateral spacing 150 between adjacent first coolant conduits 140. In this sense, aspects of the disclosure can include a radial and laterally-spaced array of coolant conduits. Non-limiting aspects can be included wherein at least one of the radial spacing 152 or lateral spacing 150 can vary, alternate, or be equally spaced between any of the adjacent first coolant conduits 140. Also as shown, the set of third coolant conduits 144 can include lateral spacing 150 between adjacent third coolant conduits 144 corresponding with lateral spacing 150 of the first coolant conduits 140.

Alternative radial or lateral spacing 152, 150 configurations of the set of first or third coolant conduits 140, 144 can be included in aspects of the disclosure, for instance, relative to the set of windings 106. In another non-limiting instance, the set of third coolant conduits 144 does not need to extend radially to the cap 108. Aspects of the disclosure can be included wherein only a subset of the set of third coolant conduits 144 are fluidly connected with the set of first coolant conduits 140, or wherein a subset of the first coolant conduits 140 are fluidly connected with the set of third coolant conduits 144.

Further examples of the fluid coolant flow 132 described herein can be reversed, such that, for instance, the fluid coolant flow 132 traverses from the first coolant cavity 120, radially through the set of second coolant conduits 142, axially through the set of first coolant conduits 140, and radially returning through the set of third coolant conduits 144 into the second coolant cavity 122, and back to the cooling system 80, based on a desired coolant flow pathway.

Thus, as described herein, aspects of the disclosure can include a method of cooling a rotatable electric machine rotor 52. The method can include receiving a fluid coolant flow 132 to one or more coolant conduits 140, such as an array of coolant conduits 140, through the set of rotor windings 106, wherein the one or more coolant conduits 140 are in a thermally conductive relationship with the set of rotor windings 106, wherein the fluid coolant flow 132 removes heat from the set of rotor windings 106. The method can further include receiving the fluid coolant flow 132 at a first axial end 102, 104 of the set of rotor windings 106 from a rotatable shaft 40. In another non-limiting example, the method can further include receiving the fluid coolant flow 132 from the array of coolant conduits 142, 144 at a second axial end 102, 104 of the set of rotor windings 106, the second axial end 102, 104 spaced from the first axial end 102, 104, and supplying the fluid coolant flow 132 to the rotatable shaft 40

Many other possible aspects and configurations in addition to that shown in the above figures are contemplated by the present disclosure. For example, one aspect of the disclosure contemplates coolant conduits that extend along alternative portions or lengths of the set of rotor windings 106. In another example, the windings or the coolant conduits can further include intervening thermally conductive layers to assist in thermal conduction while, for example, avoiding an electrically conductive relationship between respective components. In yet another example, aspects of the rotor 52 can comprise non-leaking or leak-proof components to ensure proper fluid isolation of the coolant from other aspects of the dry cavity generator. Non-limiting examples of components to ensure proper fluid isolation can include retaining rings and winding supports, such as top and bottom supports. Additionally, the design and placement of the various components such as valves, pumps, or conduits can be rearranged such that a number of different in-line configurations could be realized.

The aspects disclosed herein provide method and apparatus for cooling a rotor assembly or a set of rotor windings during electric machine operations (e.g. motor or generator operations). One advantage that may be realized in the above aspects is that the above described aspects have significantly improved thermal conduction to remove heat from the rotor assembly or set of rotor windings. The improved thermal conductivity between the rotor windings and the coolant conduits coupled with the coolant paths or coolant loops provide for heat removal in a much more effective fashion from the windings to the coolant. Another advantage of the above aspects is that a higher level of power generation may be achieved without having to use a wet-cavity configuration, due to the improved heat removal of the set of rotor windings.

The increased thermal dissipation of the rotor assembly allows for a higher speed rotation, which may otherwise generate too much heat. The higher speed rotation may result in improved power generation or improved generator efficiency without increasing generator size. Reduced thermal losses in the electric machine allow for greater efficiency and greater power density of the generator.

When designing aircraft components, important factors to address are size, weight, and reliability. The above described rotor assemblies have a decreased number of parts, making the complete system inherently more reliable. This results in possibly a lower weight, smaller sized, increased performance, and increased reliability system. The lower number of parts and reduced maintenance will lead to lower product costs and lower operating costs. Reduced weight and size correlate to competitive advantages during flight.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A rotor assembly for an electric machine comprising:
a rotor core having a rotatable shaft and defining at least one rotor post; and
a set of windings wound around the post and including a coolant conduit through-opening in the set of windings and extending axially along the post through the set of windings, and wherein the coolant conduit is in a thermally conductive relationship with a portion of the windings;
wherein heat generated in the set of windings when the rotor core rotates is transferred by conduction to a coolant flow in the coolant conduit.

2. The rotor assembly of claim 1 wherein the set of windings further includes a set of radial openings.

3. The rotor assembly of claim 2 wherein the set of radial openings fluidly connects a coolant source with the coolant conduit.

4. The rotor assembly of claim 2 wherein the set of radial openings are through-openings in the winding.

5. The rotor assembly of claim 2 wherein the set of radial openings are radial conduits.

6. The rotor assembly of claim 2 wherein the radial openings are parallel to a radial dimension of the at least one rotor post.

7. The rotor assembly of claim 2 wherein the set of windings further includes a set of coolant conduits extending axially along the post, the set of coolant conduits fluidly connected with the set of radial openings.

8. The rotor assembly of claim 7 wherein the set of windings includes at least two axially extending winding portions, and wherein each of the at least two axially extending winding portions includes a set of coolant conduits.

9. The rotor assembly of claim 2, wherein a fluid conduit flow is defined sequentially by a first subset of radial openings, the coolant conduit, and a second subset of radial openings.

10. The rotor assembly of claim 9, wherein the first subset of radial openings is axially spaced from the second subset of radial openings.

11. The rotor assembly of claim 10 wherein at least one of the first or second subsets of radial openings are located at an end turn portion of the set of windings.

12. The rotor assembly of claim 1, wherein the set of windings further includes an array of coolant conduits.

13. The rotor assembly of claim 12 wherein the array of coolant conduits includes a set of radially-spaced coolant conduits.

14. The rotor assembly of claim 12 wherein the array of coolant conduits includes a set of laterally-spaced coolant conduits.

15. A rotor assembly for an electric machine comprising:
a rotor core having a rotatable shaft and defining at least one rotor post, the at least one rotor post having a first axial end and a spaced second axial end;
a set of rotor windings wound around the post between the first and second axial ends; and
a set of radially and laterally-spaced coolant conduit through-openings in the set of windings extending axially between the first and second axial ends, and in a thermally conductive relationship with the set of rotor windings;
wherein the set of coolant conduits are internal to the set of windings.

16. The rotor assembly of claim 15 wherein the set of rotor windings further comprise rotor winding end turns axially extending beyond the first and second axial ends.

17. The rotor assembly of claim 16 further comprising a first set of radial openings located at the rotor winding end turns proximate to the first axial end and fluidly connected with the set of coolant conduits and a second set of radial openings located at the rotor winding end turns proximate to the second axial end and fluidly connected with the set of coolant conduits.

18. A method of cooling a rotatable electric machine rotor, comprising:
directing a fluid coolant flow to an array of coolant conduits extending axially through a set of rotor windings, wherein the array of coolant conduits are in a thermally conductive relationship with the set of rotor windings, so that the fluid coolant flow removes heat from the set of rotor windings as the rotor rotates.

19. The method of claim 18, further comprising receiving the fluid coolant flow at a first axial end of the set of rotor windings from a rotatable shaft.

20. The method of claim 19, further comprising receiving the fluid coolant flow from the array of coolant conduits at a second axial end of the set of rotor windings, the second axial end spaced from the first axial end, and supplying the fluid coolant flow to the rotatable shaft.
